(19) United States
(12) Patent Application Publication
(10) Pub. No.: US 2026/0050937 A1
(43) Pub. Date: Feb. 19, 2026

(54) COMPUTER-IMPLEMENTED METHOD AND COMPUTER SYSTEM FOR OBSOLESCENCE PREDICTION

(71) Applicant: ACCENTURE GLOBAL SOLUTIONS LIMITED, Dublin (IE)

(72) Inventors: Latika AGGARWAL, Gurgaon (IN); Dheeraj KHARYA, West Mumbai (IN); Selvakuberan KARUPPASAMY, Chennai (IN); Vinu VARGHESE, Bangalore (IN); Nirav Jagdish SAMPAT, Mumbai (IN); Saran PRASAD, New Delhi (IN)

(73) Assignee: ACCENTURE GLOBAL SOLUTIONS JLIMITED, Dublin (IE)

(21) Appl. No.: 18/808,915

(22) Filed: Aug. 19, 2024

(51) Int. Cl. G06Q 30/0202

(52) U.S. Cl. CPC G06Q 30/0202

(57) ABSTRACT

The present disclosure discloses systems and methods to predict obsolescence. A method includes obtaining multi-dimensional data corresponding to a product from a plurality of data sources and identifying properties associated with the product. Further, relationships between each of the identified properties is determined. A multi-dimensional nested graph for the product based on the identified properties and the determined relationships is created followed by generation of a nested relationship models from the created multi-dimensional nested graph. Additionally, a transactional data node indicating a relationship between the product and the current sales data is created. Furthermore, a graph embedding values based on the created transactional data node and the nested relationships is created. Consequently, an obsolescence data for the product based on the created graph embedding values, the customer purchase patterns, a product inventory forecast data and a sales data is predicted and sends to the user device.

### FIELD OF THE INVENTION

Various embodiments described herein relate generally to obsolescence prediction Specifically, a system and method for predicting obsolescence of a plurality of products using generative artificial intelligence (Gen AI), machine learning (ML) and deep learning (DL) techniques.

### BACKGROUND

Obsolescence signifies the progressive decline in the utility or economic value of a product or system due to due to various factors like advancements in technology, changes in needs, or deterioration of material. Due to the rapid pace of technological change, product lifecycles are becoming increasingly shorter. While this rapid innovation allows for long-term product development strategies, it also presents significant challenges in managing product obsolescence. To address this challenge, various techniques for predicting obsolescence and product life cycles have been developed. However, existing techniques may rely on Enterprise Resource Planning (ERP) systems to predict obsolescence. Furthermore, these systems may use future forecasts to identify potential risks associated with products becoming obsolete. While traditional systems employ future forecasts to identify potential risks, their accuracy can be unreliable, especially in rapidly changing markets.

### SUMMARY

Implementations of the present disclosure are generally directed to obsolescence prediction using generative artificial intelligence (Gen AI), machine learning (ML) and deep learning (DL) techniques. More particularly, implementations of the present disclosure are directed to systems and methods for predicting obsolescence of a plurality of products.

In general, innovative aspects of the subject matter described in this specification provide systems and methods for predicting obsolescence of a plurality of products using generative artificial intelligence (Gen AI) and machine learning (ML) based techniques. The system may obtain multi-dimensional data corresponding to a product from a plurality of data sources. The multi-dimensional data may include at least one of a product size, product ingredients, a geographic location, people lifestyle, climate conditions, and an actual sales report for the product. Thereafter, properties associated with the product based on the obtained multi-dimensional data may be identified. Furthermore, relationships between each of the identified properties of the product based on type of the properties and type of the product may be determined. Thereafter, multi-dimensional nested graph may be created based on the identified properties and the determined relationships using a nested graph technique, wherein the multi-dimensional nested graph may represent relationship of the determined properties with market demands of the product. Moreover, a plurality of nested relationship models may be generated from the created multi-dimensional nested graph, wherein the plurality of nested relationships models may represent the properties and relationships for a group of products and wherein the plurality of nested relationship models is generated based on nested relationships common to specific group of products. Additionally, at least one transactional data node may be created, indicating a relationship between the product and current sales data based on the generated plurality of nested relationship models. Further, a plurality of graph embedding values may be created based on the created at least one transactional data node and the nested relationships, wherein the plurality of graph embedding values may capture at least one of purchase patterns, a trending history, product details, customer details, and demographics data. Further, customer patterns with high confidence score may be identified by applying the created plurality of graph embedding values onto a trained ML model. Consequently, an obsolescence data for the product may be predicted, based on the identified customer patterns and based on at least one of a forecast data and a sales data and may output the predicted obsolescence data for the product on a user interface of a user device.

The present disclosure further describes a system for implementing the method provided herein. The present disclosure also describes computer-readable storage media coupled to one or more processors and having instructions stored thereon which, when executed by the one or more processors, cause the one or more processors to perform operations in accordance with the method described herein.

It is appreciated that methods in accordance with the present disclosure can include any combination of the aspects and features described herein. That is, the method in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DRAWINGS

Various embodiments in accordance with the present disclosure will be described with reference to the drawings, in which:

FIG. 1 illustrates an example environment that may be used to execute implementations of the present disclosure.

FIG. 2A-2D illustrates comparison between dataset obtained in an exemplary implementation of the traditional obsolescence predictor and the obsolescence predictor as per the embodiments of present disclosure.

FIG. 3 illustrates an example system architecture of obsolescence predictor in accordance with implementations of the present disclosure.

FIG. 4 illustrates a block diagram that presents obsolescence prediction manager in accordance with implementations of the present disclosure.

FIG. 5 illustrates an exemplary implementation of the multi-dimensional nested graph in accordance with implementations of the present disclosure.

FIG. 6 illustrates an exemplary implementation of plurality of nested relationship models from the created multi-dimensional nested graph, in accordance with implementations of the present disclosure.

FIG. 7 illustrates a pattern cluster data generated by the knowledge inference engine, in accordance with implementations of the present disclosure.

FIG. 8A-8C illustrates visual representation of user interface, in accordance with implementations of the present disclosure.

FIG. 9 illustrates the flow diagram of an example method for obsolescence prediction, in accordance with implementations of the present disclosure.

FIG. 10 illustrates the flow diagram of an example method for custom model training by obsolescence optimizer, in accordance with implementations of the present disclosure.

FIG. 11 illustrates a computer system that may be used to implement the system to predict obsolescence in accordance with implementations of the present disclosure, in accordance with implementations of the present disclosure.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” (e.g., “for example”, “an example of”, by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the invention as set forth in the claims.

Obsolescence refers to the process by which an asset, such as a system, component, or device, loses its functionality or utility. Either, the asset may no longer be effective for its intended use, or the specific form and function may no longer be readily available for production or repair. Product manufacturers may discontinue specific assets due to various factors impacting profitability. This could occur when a product becomes less lucrative compared to alternatives that utilize the same resources. Alternatively, discontinuation might be driven by external forces such as market shifts, legislative changes, internal policy adjustments, or product line rationalization following mergers and acquisitions. Therefore, predicting when a product might become obsolete is crucial for industries. Further, more and more companies have large amounts of data that are valuable resources for obsolescence management. However, as these resources cannot be sufficiently analyzed and evaluated, they are worthless for the company. To utilize the large amount of data, there is a need of artificial intelligence (AI) and machine learning (ML) techniques to be developed for the prediction and detection of obsolescence. Specifically, there is a need of obsolescence prediction method to enable real-time predictions of product irrespective of fluctuating market demands and rapidly changing markets.

In view of this, implementations of the present disclosure propose a system and a method to predict obsolescence, to overcome above mentioned drawbacks of traditional obsolescence predictor. The present disclosure utilizes an intelligent technique that analyzes various dimensions of product features like customer profile, location profile, customer purchase profile along with historic sales data to predict the obsolescence. Specifically, multi-dimensional layer of ontology/taxonomy is created for obtained product features, thereby leading to improved accuracy compared to actual market sales and past trends. Additionally, the system and method disclosed in the present disclosure incorporates nested graph technique and graph embeddings for more precise predictions. Specifically, the present disclosure identifies the in-depth properties or features of the product. In the present disclosure, a nested graph is generated by obtaining the properties of product like, for example, for beverages product, data like, container size, location, ingredients, customer age ranges, product sales, etc. Furthermore, relationships across products, sales and purchase history are identified using nested graph. For an instance, the nested graph determined the relationship between the product properties and market demands. Furthermore, the proposed solution can predict the obsolescence of a new product by identifying the attributes of the new product that matches with other similar product attributes, using the nested graph technique and graph embeddings. In this way, the proposed disclosure may generate information related to new, emerging, established, outdated, and/or future product trends based on real-time transaction data related to consumer requirement behavior in combination with other relevant sources to predict product obsolescence over a period of time. Furthermore, in some implementations, the obsolescence prediction data may be provided to one or more clients or customers of the entity that has the access to the real-time transaction data, which may enable accurate demand forecasting, inventory planning to avoid stockouts or oversupplies, and/or improved communication with customers. Thus, the production cycle in industries may predict the lifetime of the product and only produce the limited stock in industries which can be consumed as per the product lifecycle. Moreover, in case the product is about to be obsolete, the industry may either introduce improvement in the same product or can plan to explore new opportunities to divert the production goals in the industry. Accordingly, the industry failure due to obsolescence of product can be conserved by taking timely actions based on the obsolescence prediction.

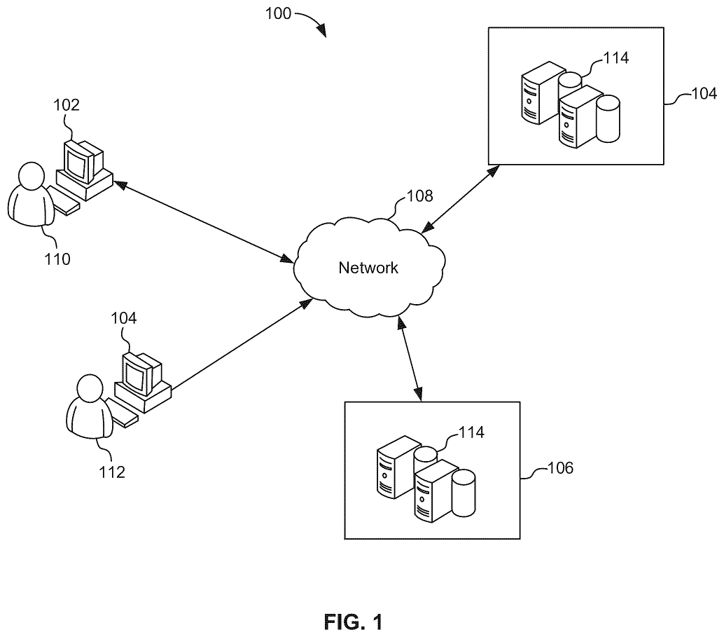

FIG. 1 depicts an example environment 100 that can be used to execute implementations of the present disclosure. In some examples, the example environment 100 enables users associated with respective systems to execute requests to generate content by invoking a trained language model in accordance with implementations of the present disclosure. The example environment 100 includes computing devices 102 and 104, back-end systems 106, and a network 110. In some examples, the computing devices 102 and 104 are used by respective users 114 and 116 to log into and interact with the platforms and running applications according to implementations of the present disclosure.

In the depicted example, the computing devices 102 and 104 are depicted as desktop computing devices. It is contemplated, however, that implementations of the present disclosure can be realized with any appropriate type of computing device (e.g., smartphone, tablet, laptop computer, voice-enabled devices). In some examples, the network 110 includes a local area network (LAN), wide area network (WAN), the Internet, or a combination thereof, and connects web sites, user devices (e.g., computing devices 102, 104), and back-end systems (e.g., the back-end systems 106). In some examples, the network 110 can be accessed over a wired and/or a wireless communications link. For example, mobile computing devices, such as smartphones can utilize a cellular network to access the network 110.

In the depicted example, the back-end systems 106 each include at least one server system 120. In some examples, the at least one server system 120 hosts one or more computer implemented services that users can interact with by using computing devices. For example, components of enterprise systems and applications can be hosted on one or more of the back-end systems 106. In some examples, a back-end system can be provided as an on-premises system that is operated by an enterprise or a third-party taking part in cross-platform interactions and data management. In some examples, a back-end system can be provided as an off-premises system (e.g., cloud or on-demand) that is operated by an enterprise or a third-party on behalf of an enterprise.

In some examples, the computing devices 102 and 104 each include computer 1 executable applications executed thereon. In some examples, the computing devices 102 and 104 each include a web browser application executed thereon, which can be used to display one or more web pages of platform running applications. In some examples, each of the computing devices 102 and 104 can display one or more GUIs that enable the respective users 114 and 116 to interact with the computing platform. In accordance with implementations of the present disclosure, the back-end systems 106 may host enterprise applications or systems that require data sharing and data privacy. In some examples, the computing device 102 and/or the computing device 104 can communicate with the back-end systems 106 over the network 110.

In some implementations, at least one of the back-end systems 106 can be implemented in a cloud environment that includes at least one server system 120. In the example of FIG. 1, the back-end server 106 can represent various forms of servers including, but not limited to, a web server, an application server, a proxy server, a network server, and/or a server pool. In general, server systems accept requests for application services and provide such services to any number of client devices (for example, the computing device 102 over the network 110).

In some implementations, the back-end system 106 can be used to implement an Artificial Intelligence (AI)-enabled platform trained to generate content relevant for individuals in accordance with contextual information and training data indicative of reactions of similar consenting individuals to certain content items (i.e., neuroscience responses). The AI-enabled platform can include a trained generative AI model that generates such personalized content. The generative AI model can be trained using a training corpus that combines data representing neuroscience responses of the individuals to stimuli triggered by various content items and corresponding context data acquired from a plurality of sources.

Various examples depicting obsolescence prediction, are described in detail in conjunctions with figures below.

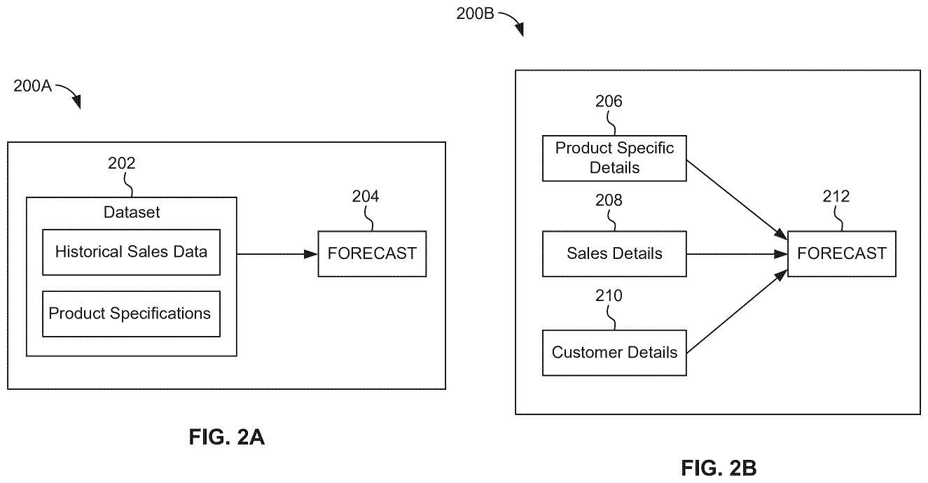

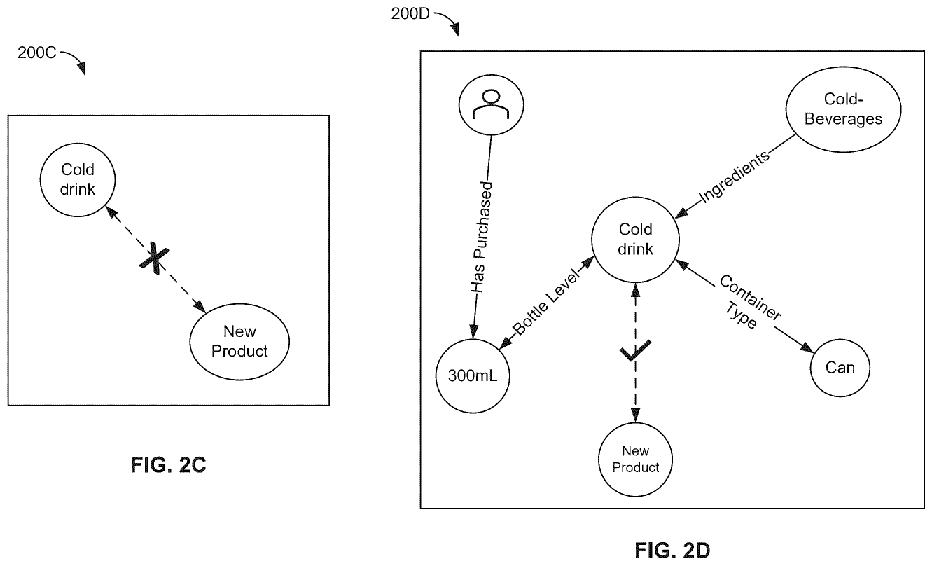

FIG. 2A-2D illustrates the comparison between dataset obtained in the exemplary implementation of the traditional obsolescence predictor and the obsolescence predictor as per the embodiments of present disclosure. As shown in FIG. 2A, the traditional obsolescence predictor 200A predicts obsolescence using a dataset 202 only. The dataset 202 includes only historical sales data and product specifications. However, as shown in FIG. 2B, the proposed obsolescence predictor 200B, in accordance with implementations of the present disclosure, predicts obsolescence based on multidimensional features like, product specific details 206 (for example features, brands, categories etc.), sales details 208 (for example historical sales data, invoice data and quantity sold etc.) and customer details 210 (for example customer behavior. customer profile and geographical details etc.).

As shown in FIG. 2C, when a new product is launched in the market, traditional obsolescence predictor 200C will not be able to predict the obsolescence of new product as historical data will not be available. For example, a new product like a beverage drink is launched in the market. The traditional system cannot predict obsolescence for the product because there is no historical data. However, as shown in FIG. 2D, the proposed obsolescence predictor 200D, in accordance with implementations of the present disclosure, may predict the obsolescence of the product using the attributes of the new product that matches with other similar product attributes. For example, in launch of a new variant of beverage drink, the proposed solution may compare the new beverages with the attributes of other drinks in the market which has similar parameters, such as a cold drink, to make a prediction about how long it is likely to be popular. The attributes may include bottle level, ingredients and container type etc.

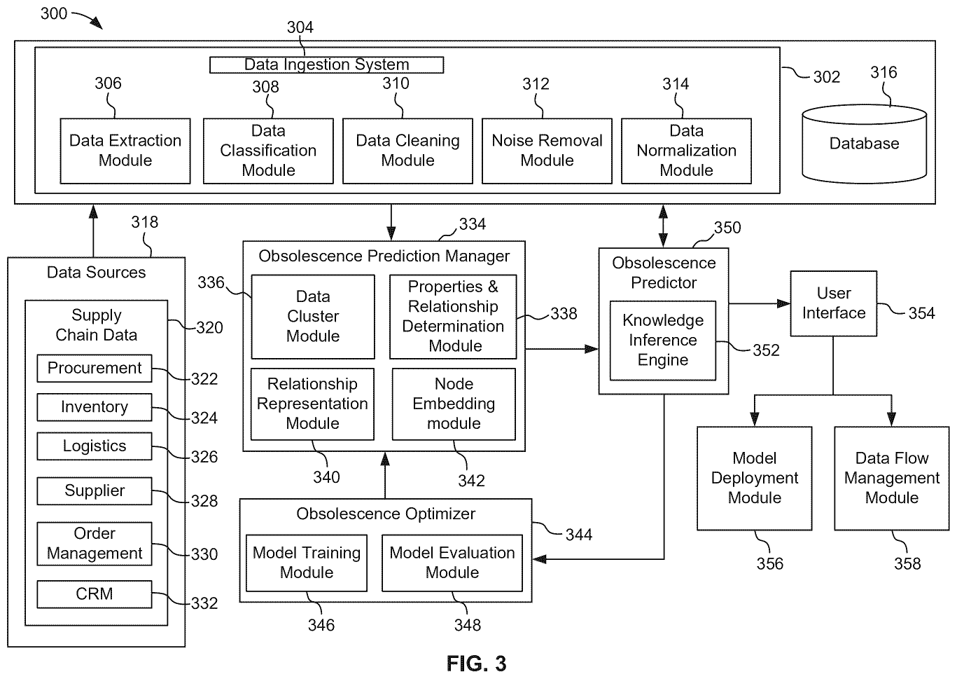

FIG. 3 illustrates an example system architecture 300 to predict obsolescence using artificial intelligence (AI), machine learning (ML) and deep learning (DL) techniques, in accordance with implementations of the present disclosure. The system architecture 300 includes one or more data sources 318, a data ingestion system 304, an obsolescence prediction manager 334, an obsolescence predictor 350, an obsolescence optimizer 344, a user interface 354, a model deployment module 356 and a data flow management module 358.

The data ingestion system 304 may include a data processing module 302 and a database 316. The data processing module 302 may further include a data extraction module 306, a data classification module 308, a data cleaning module 310, a noise removal module 312 and a data normalization module 314. The data ingestion system 304 may obtain multi-dimensional data corresponding to a product from the one or more data sources 318. The data processing module 302 may process the obtained multiple-dimensional data and stores it in the database 316. Although not depicted in FIG. 3, an embedder can be provided (e.g., a pre-trained ML model) that processes the obtained multiple-dimensional data.

The one or more data sources 318 may include data sources for a supply chain data 320, including a procurement 322 data source, an inventory 324 data source, a logistics 326 data source, a supplier 328 data source, an order management 330 data source and a CRM (Customer Relationship Management) 332 data source. The supply chain data 320 is the data related to the entire process of receiving a product from its initial conception to the delivery to the end customer. The supply chain data 320 can be used to improve efficiency, reduce costs, and track the progress of products through the supply chain. Specifically, the procurement 322 data source may provide information about the process of acquiring goods and services, such as, vendor lists, purchase orders, and contracts or the like. The inventory 324 data source may provide information about the goods a company has on hand, such as stock levels, storage locations, and reorder points. The logistics 326 data source may provide information about the process of moving goods from suppliers to customers, such as transportation routes, warehouse locations, and delivery schedules, or the like. The supplier 328 data source may provide information about customer orders, such as order details, fulfillment status, and shipping information, or the like. The CRM 332 data source may provide information about the company's customers, such as contact information, sales history, and preferences, or the like.

The data extraction module 306 may obtain the multi-dimensional data. Herein, the multi-dimensional data refers to product features, customer behavior and market demands. For each dimension multiple features are associated with it and various dimensions of features of the product are obtained, like customer profile, location profile, customer purchase profile and historic sales data, to predict the obsolescence. For example, the multi-dimensional data corresponding to the product from the plurality of data sources, may include, but not limited to, a product size, product ingredients, a geographic location of the product, a customer lifestyle data, climate conditions, and a current sales data for the product. For example, various dimensions of features of the product are obtained, like customer profile, location profile, customer purchase profile and historic sales data, to predict the obsolescence.

The data classification module 308 may classify the obtained multi-dimensional data from the data extraction module 306, into plurality of categories. For an instance the categories may include, but not limited to, product data (for example, stock keeping unit (SKU), description, price and attributes), sales data (for example, order information, sales, customer, shipping, etc.), order data (for example, customer no., purchase order, etc.) and supplier/vendor data (supplier name, code, industry, etc.).

Further, the data cleaning module 310 may identify and address inconsistencies, errors, and missing values within the multi-dimensional data. The noise removal module 312 may eliminate unwanted information like outliers or random fluctuations. Moreover, the data normalization module 314 may ensure data consistency by transforming features into a uniform format suitable for analysis by machine learning (ML) models.

The obsolescence prediction manager 334 may receive the multi-dimensional data (processed by the data processing module 302) from the database for further data processing and generation of obsolescence predictions for each product. The obsolescence prediction manager 334 further may include a data cluster module 336, a properties & relationship determination module 338, a relationship representation module 340 and a node embedding module 342.

The data cluster module 336 may identify properties associated with the product based on the obtained multi-dimensional data and retrieve specific data relevant for product obsolescence prediction. The specific data retrieved is based on the product features for clustering. Examples might include product attributes (type, nature, brand), sales data (quantity sold), and potentially additional information like historical pricing or production costs.

Further, the data cluster module 336, after identifying the properties associated with the product, may cluster or group products with similar characteristics, by using k-means clustering a. K-means is an unsupervised machine learning algorithm that iteratively partitions data into a pre-defined number of clusters (k) based on their similarity. K-means iteratively groups products together based on their similarity in terms of features like type, nature, quantity, and brand. Products with similar characteristics will be assigned to the same cluster. Based on these similarities, products will be grouped into clusters. Each cluster will likely represent a category of products with similar obsolescence risks.

Moreover, the data cluster module 336 may analyze the customer behavior by analyzing invoice data that includes information about products purchased together in a single transaction. For an instance, generative artificial intelligence (gen AI) techniques, like generative adversarial networks (GANs) or variational autoencoders (VAEs), can be employed to analyze invoice data and identify the purchase patterns. By using gen AI techniques, the relationships between products frequently bought together can be identified. Customers who purchase similar product combinations can then be clustered together, thereby, potentially revealing purchase pattern or product affinities.

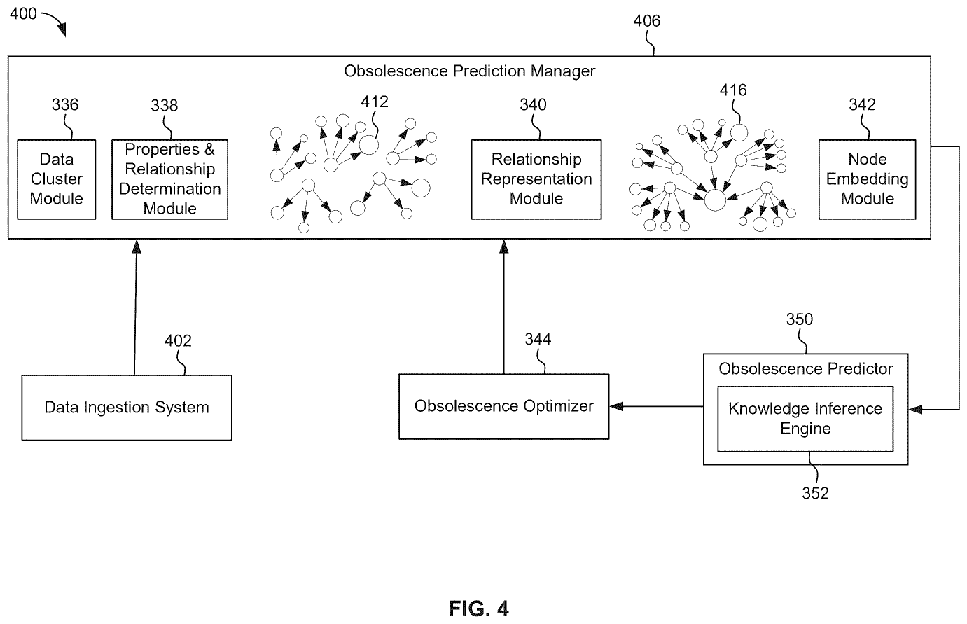

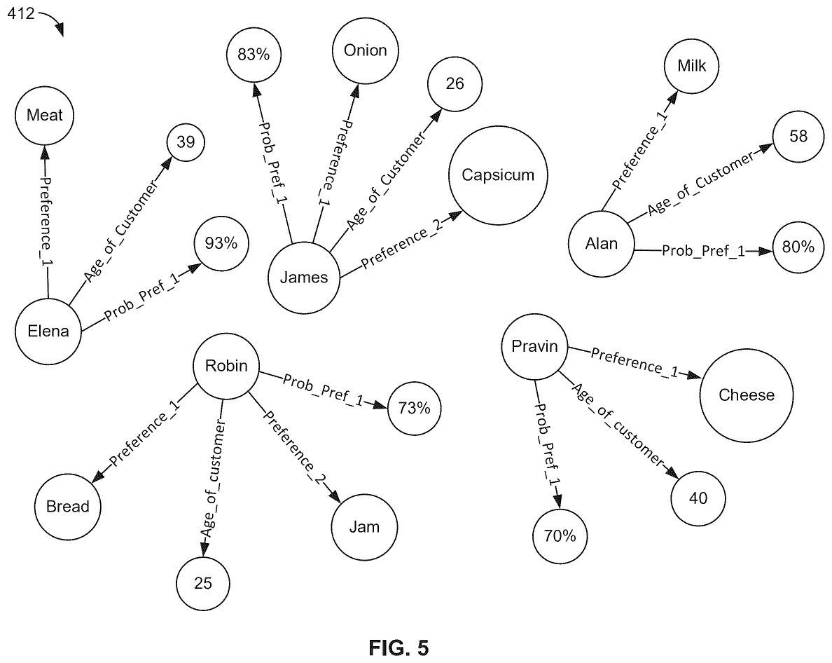

Thereafter, from each of the clusters generated by the data cluster module 336, the properties & relationship determination module 338 may identify properties associated with the product based on the obtained multi-dimensional data and determines relationship between the customer & the products purchased by the customer. For example, the properties & relationship determination module 338 may obtain the in-house inventory details and identify its associated properties. Moreover, the properties & relationship determination module 338 may generate a multi-dimensional nested graph 412 based on the identified properties and relationships with the products in the cluster. Herein, the properties & relationship determination module 338 may utilize a nested graph technique, for example graph neural networks, to generate the multi-dimensional nested graph based on the properties and attributes of the products within the same cluster. The multi-dimensional nested graph 412 is further described in detail in FIG. 4 and FIG. 5.

The relationship representation module 340, based on the multi-dimensional nested graph 412, may represent the nested relationships based on properties and relationships with the products in the cluster.

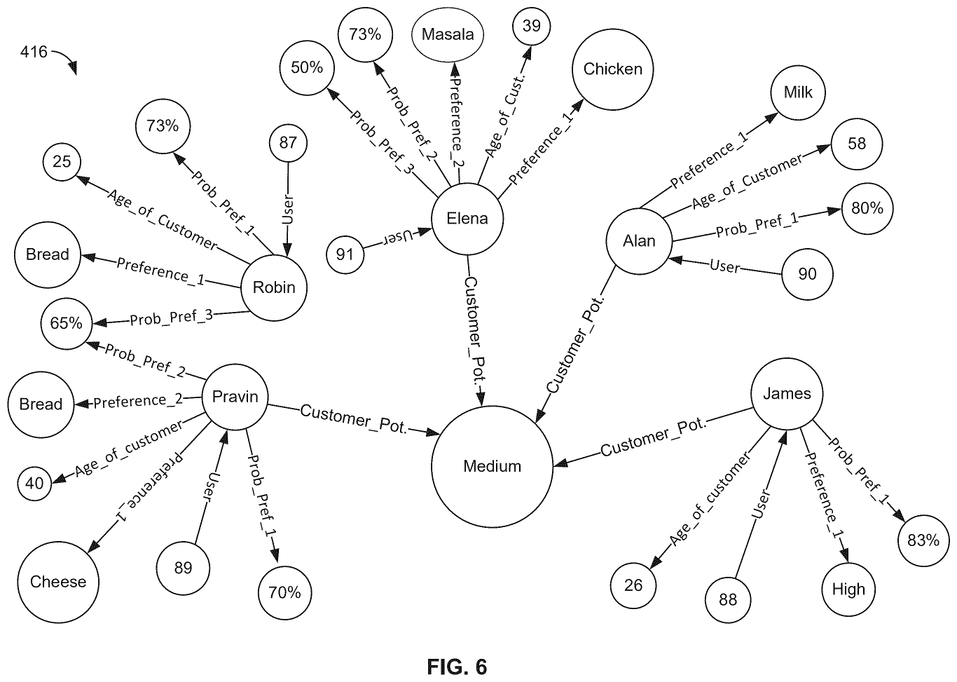

Further, the relationship representation module 340 may generate a plurality of nested relationship model 416 based on the created multi-dimensional nested graph 412. The plurality of nested relationship model 416 represents the identified properties and the determined relationships for a group of products. The plurality of nested relationship model 416 is further described in detail in FIG. 4 and FIG. 6.

Further, relationship representation module 340 may create at least one transactional data node indicating a relationship between the product and the current sales data based on the generated plurality of nested relationship models. Specifically, the transactional node establishes relationships between products and the specific sale thereby, allowing system to analyze the frequency of products that are purchased together, quantities, and the price. For example, by analyzing invoice data, the system can identify customer buying patterns based on specific purchases. Analyzing the invoice data can reveal trends like customer preferences for specific product combinations, seasonal buying habits, and brand loyalty, or the like.

Thereafter, the node embedding module 342 may create a plurality of graph embedding values based on the created at least one transactional data node and the nested relationship model. Specifically, the plurality of graph embedding values may capture at least one of customer purchase patterns, a product trending history, product information, customer information, and demographics data. Further, the obsolescence predictor 350 may predict an obsolescence data for the product based on the created plurality of graph embedding values, the customer purchase patterns, a product inventory forecast data and a sales data. The predicted obsolescence data for the product may be displayed on the user interface 354 of a user device. Moreover, the predicted obsolescence data for the product may be stored in the database 316.

The obsolescence optimizer 344 may be provided to optimize the accuracy of obsolescence predictor 350. The obsolescence optimizer 344 may further include a model training module 346 and a model evaluation module 348.

The model training module 346 may utilize the graph embedding values created by the node embedding module 342 and generate an updated multi-dimensional data. For example, the model training module 346 may incorporate the updated multi-dimensional data like new sales data or changes in product attributes. Furthermore, the model training module 346 may analyze the updated multi-dimensional data and select an appropriate model for the retraining process. The selection of appropriate model may involve selecting a specific type of model suitable for the product data's characteristics and the desired prediction accuracy.

The model training module 346 may utilizes the updated multi-dimensional data and the selected model to retrain a set of machine learning (ML) models. The retraining of the ML models may include employing a plurality of ML models simultaneously with different hyperparameters (tuning parameters) to explore the data and identify the best performing model. The model evaluation module 348 may further evaluate the performance of each retrained model by validating its predictions against actual or historical data and determine a forecast error. By analyzing the validation results and the corresponding forecast errors, the model evaluation module 348 may identify the optimal machine learning model. Eventually, the model evaluation module 348, based on the identified optimal machine learning model, refine the initially predicted obsolescence data for the product.

Moreover, the present disclosure discloses a novel process to generate the forecast error to optimize the obsolescence prediction. For example, a set of forecasts (f1, f2, f3 . . . fn) are generated for the new and existing products. Subsequent to this, forecast errors (e1, e2, . . . , en) are calculated specifically for newly introduced products. The forecast errors are then correlated against the nested graph embeddings of the existing knowledge base to identify potential discrepancies in product relationships. The obsolescence optimizer 344 refines the relationships by scrutinizing product features and realigning connections within the nested graph. Nodes with unsuccessful prediction outcomes undergo a reevaluation of their associated embeddings and relationships. The optimized embeddings are subsequently applied to new products, improving the overall accuracy of obsolescence predictions. Herein, the optimized embeddings refer to the numerical representations of products within the nested graph that have been adjusted to improve the accuracy of obsolescence predictions.

In an example, in the first iteration, 20 products exhibiting forecast errors are mapped to their corresponding node embeddings, resulting in a 35% forecast error. Through relationship realignment in the second iteration, the forecast error rate is reduced to 22%. Finally, the incorporation of additional nested relationships using graph embeddings in the third iteration yields a significant improvement, lowering the forecast error to 12%. Thus, by dynamically adapting the nested graph based on forecast errors, the system can improve the accuracy of obsolescence predictions for both existing and new products.

Furthermore, the model deployment module 356 and data flow management module 358 are provided to simulates the impact of obsolescence data displayed by the user interface, and then proactively takes corrective actions in real-time, thereby, optimizing the product performance, production, and inventory management. The model deployment module integrates the trained ML models (by obsolescence optimizer 344) into applications or system where it can be used further to generate obsolescence predictions. Moreover, model deployment module enables other systems to access the functionalities of the obsolescence prediction model.

Specifically, the model deployment module 356 and the data flow management module 358 may utilize the predicted obsolescence data to simulate the product's performance in a virtual environment. Based on the results obtained from the product performance simulation, at least one action is defined to be performed on the product and execute the action remotely and in real-time.

The action may include, but not limited to, modifying product maintenance cycle, a product production cycle, and inventory numbers. For example, modifying product maintenance cycle may involve adjusting the frequency or type of maintenance activities required for the product based on its predicted lifespan. In another example, modifying the product production cycle may recommend changes to the product's production schedule or process depending on the obsolescence forecast, thereby adjusting production volumes or introducing design changes to mitigate obsolescence. In another example, modifying the inventory numbers may include triggering adjustments to inventory levels to avoid overstocking items nearing obsolescence.

Moreover, the model deployment module 356 and data flow management module 358 may execute the actions, remotely and in real-time. For an instance, the model deployment module 356 and data flow management module 358 may include communication with an industrial plant where the product is used. The data flow management module 358 may transmit the defined action as a control signal to the industrial plant for further management of operations within the plant.

FIG. 4 illustrates a block diagram that presents the obsolescence prediction manager 334 in accordance with implementations of the present disclosure. Herein, the obsolescence prediction manager is described in relation to FIG. 3.

The data cluster module 336 cluster/group the products based on attributes like, but not limited to type, nature and quantity. The data cluster module 336 may extract data relevant to the customer and the specific products purchased by the customer.

Further, the properties and relationship determination module 338 may identify relationships between a specific customer and the various products they have purchased from different product categories. Moreover, inventory information for the products purchased by the customer across different product categories is extracted. The inventory data may include data like, but not limited to, stock levels, purchase history, and product cost.

Further, the properties and relationship determination module 338 may generate the multi-dimensional nested graph 412, including nodes and edges, to represent the extracted information. The multi-dimensional nested graph 412 is described further with the help of an exemplary embodiment, in FIG. 5. The nodes and edges within the connected graph represent the relationships and properties of the products. Each product in the customer's purchase history is represented by a node in the graph. The nodes are assigned attributes based on the extracted inventory information. The attributes may include, but not limited to, quantity purchased, purchase date, or product price. The edges are used to connect nodes and represent the extracted relationships. For example, edges are created between the customer node and the product nodes they purchased, thereby, representing the customer's buying behavior. In another example, edges are created between product nodes, thereby, representing relationships between the identified properties of those products.

The relationship representation module 340 may generate the plurality of nested relationship model 416 based on the generated multi-dimensional nested graph 412. Specifically, the relationship representation module 340 may create a sample data based on the multi-dimensional nested graph 412 to generate nested relationship model 416. The plurality of nested relationship model 416 is described further with the help of an exemplary embodiment, in FIG. 6.

Moreover, a node level relationship node across product clusters, a cluster level relationship node and a nested weight relationship node can be generated based on the multi-dimensional nested graph. The node level relationship node across product clusters represents relationships between products across different product clusters within the nested graph. The cluster level relationship node represents relationships within a specific product cluster. The nested weight relationship node represents the strength of the various relationships identified within the nested graph. By assigning weights, the system can prioritize specific relationships based on their relevance to product obsolescence prediction.

Furthermore, a nested metric value is determined for identifying close network nodes between each of the generated node level relationship node across the product clusters, the cluster level relationship node and the nested weight relationship node. For instance, the nested metric value may calculate the exponential component of all the relations within the nested graph. In some examples, the nested metric value may be identifying as:

$$Nested Metrics NM = exp ( Summation ( pi , ni , ji , jn … ni , nn ) )$$

Wherein, p denotes the cluster names;
J denotes the relationship names; and
N denotes the nested relationship count.

Specifically, the nested metrics is the custom calculation for generating the close network nodes. The nested metrics assesses the multi-dimensional connectivity of a product within a specific cluster. In simpler terms, it quantifies how a particular product is connected to other nodes across different dimensions (e.g., customer segments, related products) within the nested graph.

Thereafter, based on the determined nested metric values, the plurality of nested relationship model 416 may be generated. The plurality of nested relationship model 416 may determine the identified relationships between different entities within the multi-dimensional nested graph.

Further, to create the at least one transactional data node indicating the relationship between the product and the current sales data, the properties & relationship determination module 338 may include identifying a customer behavior on purchase pattern, obtaining data from external data sources, determine the relationship between the product and the current sales data based on the customer behavior purchase pattern and the data from external data sources, and eventually creating the at least one transactional data node.

Specifically, the customer behavior on purchase patterns is identified by applying user specific data into a trained machine-learning (ML) model. For an instance, the user-specific data (for example, purchase history details or customer demographics) is fed into a pre-trained ML model. The ML model analyzes the user specific data to identify the customer's buying patterns related to the specific product, thereby, identifying trends like, but not limited to, frequency of purchase, preferred quantities, or potential seasonality in their purchases.

Further, data related to the product from a plurality of external data sources is obtained by the relationship representation module 340. The data related to the product from a plurality of external data sources may include, but not limited to, inventory levels data, seasonal sales data, and trending products data. The inventory level data may provide information on the current stock levels of the product, thereby, providing insights into potential supply constraints or overstocking issues. The seasonal sales data may provide information of historical data of fluctuation in product sales, thereby identifying seasonal trends and potential peaks or dips in demand. The trending products data may provide information of on currently popular or trending products within the same category or market segment, thereby, identifying shifts in customer preferences that may impact the product's future sales.

Thereafter, by analyzing the identified customer behavior (from the machine learning (ML) model), the obtained external data (inventory, seasonal sales, trending products), the relationship representation module 340 determines the relationship between the product and current sales data.

The relationship representation module 340, further include creating at least one transactional data node indicating the relationship between the product and the current sales data. For example, the transactional node can identify the customer behavior on the purchase patterns based on the invoice data. In another example, the transactional node helps in identifying and maintaining inventory levels, seasonal sales, top trending products etc., thereby, predicting the obsolescence more accurately.

The node embedding module 342 may create the plurality of graph embedding values based on the created at least one transactional data node and the nested relationships. Specifically, the node embedding module 342 may create a sample data containing information associated with each nested node in the existing multi-dimensional nested graph 412 (generated by the properties & relationship determination module 338). The sample data may include details about the product and its connected properties within the multi-dimensional nested graph. Further, the ML model by may be used to generate a synthetic nested node data. The ML model may be trained on a massive dataset of text and code related to products, markets, and customer behavior. Specifically, by input the sample data into the ML model, the node embedding module 342 can generate new, synthetic data that reflect similar characteristics, thereby, capturing additional relationships not explicitly present in the original data. Furthermore, based on the synthetic data generated by the ML model, a hypothetical nested node graph is generated for a specific. This hypothetical nested node graph refers to an augmented representation of the product's relationships and properties within the multi-dimensional nested graph. Thereafter, a trained graph network model is used to create a plurality of graph embedding values for the nodes within the generated hypothetical nested node graph. Specifically, a nested metric proportionate value is computed for product clusters related to the multi-dimensional data. The nested metric proportionate value may assess the relationship of different product clusters within the context of the specific product being analyzed. The computed nested metric proportionate value can be then used to create the graph embedding values for the hypothetical nested node graph. For an instance, the graph embedding values may capture purchase patterns, trending history and product details, customer details, demographics etc. In some examples, the nested metric proportionate value may be identifying as:

$$Nested Metrics Proportionate NMP = exp ( pi , ni , ji , jn … ni , nn ) )$$

Wherein, p denotes the cluster names;
J denotes the relationship names; and
N denotes the nested relationship count.

In the present disclosure, a novel process to generate the nested graph embeddings is disclosed. The novel process may be expresses as:

$${E}_{n} = \frac{N M P ( {e}^{x} - {e}^{- x} )}{{e}^{x} - {e}^{- x}}$$

Wherein, NMP denotes the nested metrics proportionate for the clusters related to two different data which has its own nested set of relationships within multi-dimensional nested graph; and
Eₙ denotes the no. of graph embeddings to be generated.

Eventually, the plurality of graph embedding values created for the hypothetical nested node graph are replicated for the original enterprise nested nodes within the multi-dimensional nested graph. The insights captured in the augmented representation (hypothetical graph) are applied back to the original data structure.

The obsolescence predictor 350, further, predict the obsolescence data for the product based on the created plurality of graph embedding values, the customer purchase patterns, the forecast data and the sales data. The obsolescence predictor 350 may include a knowledge inference engine 352.

Unlike traditional methods that directly inputs embedding generations into a ML pipeline, the proposed system utilizes a transformer model that is custom trained with deep learning (DL) techniques. The transformer model is specifically trained to support multi-dimensional data. Specifically, the knowledge inference engine 352 trains the transformer model using the pattern cluster data (described further in FIG. 5), relationships nodes and the graph embedding values, to identify the consumer purchase patterns with a high degree of confidence. Identifying the high-confidence patterns allows the obsolescence predictor 350 to predict future customer behavior and design targeted offers or incentives to attract customers and potentially mitigate product obsolescence risks.

The transformer model, based on identified consumer purchase patterns along with the graph embedding values, the forecast data and the sales data, predicts the relationships between the product, current sales, and its purchase history.

Eventually, the obsolescence data for the product is predicted by the obsolescence predictor 350, for a defined timeframe. The obsolescence data may include various insights like, but not limited to, market demand data, the customer demand data customer forecast data, future sales insight, purchasing trends, recommendations on product inventory allocations, route schedules, and transportation cost.

FIG. 5 illustrates an exemplary implementation of the multi-dimensional nested graph 412 in accordance with implementations of the present disclosure. Nodes and edges within the multi-dimensional nested graph 412 represent the relationships and properties of the products. Specifically, the nodes may include information attributes like people (Elena, James, Alan, Robin and Pravin), product (meat, onion, capsicum, milk, bread, jam and cheese), customer age and probability of buying specific product. The edges, connecting the nodes, represent relationships among nodes. For example, Elena (aged 39) prefers buying meat and the probability of Elena buying meat is 93%. James (aged 26) prefers buying onion and capsicum. The probability of James buying onion is 83%. Alan (aged 58) prefers buying milk and the probability of Alan buying milk is 80%. Robin (aged 25) prefers buying bread and jam. The probability of Robin buying bread is 73%. Pravin (aged 40) prefers buying cheese and the probability of Pravin buying cheese is 70%.

FIG. 6 illustrates an exemplary implementation of plurality of nested relationship model 416 based the created multi-dimensional nested graph 412 (Refer FIG. 5), in accordance with implementations of the present disclosure. The process of generating nested relationship model 416 involves analyzing the multi-dimensional graph 412 to identify groups of products that share commonalities. For example, Pravin, Elena, Alan and James have medium customer potential.

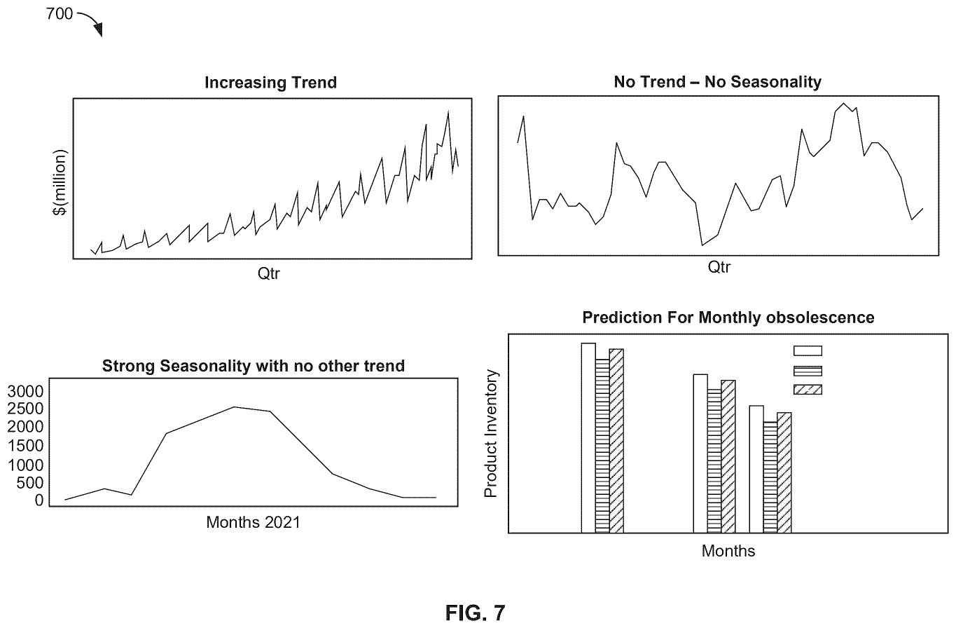

FIG. 7 illustrates the pattern cluster data generated by the knowledge inference engine 352, in accordance with implementations of the present disclosure. Even though the historic data not available, the proposed system could be able to identify the trends/seasonality/patterns based on the existing relationships. For example, the knowledge inference engine 352 may identify the pattern in the purchase. For example, a person who bought 300 ml cold beverage also bought chips and biscuits. Similarly, aggregate pattern trends can be aggregated and iterate over it, to get the top successive trends & most valuable brands for specific products. Specifically, by analyzing the pattern cluster data, deep insights into customer preferences, habits, and purchasing behaviors can be determined. Further, the pattern cluster data can be used to train the transformer model to identify consumer patterns with high confidence score's which can be used further to attract customer. Moreover, by analyzing the pattern cluster data, future customer behavior can be predicted, such as what products a customer is likely to purchase together or what products might be in high demand during certain seasons. In another instance, determination of product relationships can help optimize inventory levels and prevent stockouts or overstocking. Thus, the pattern cluster data enables data-driven decision making to predict obsolescence.

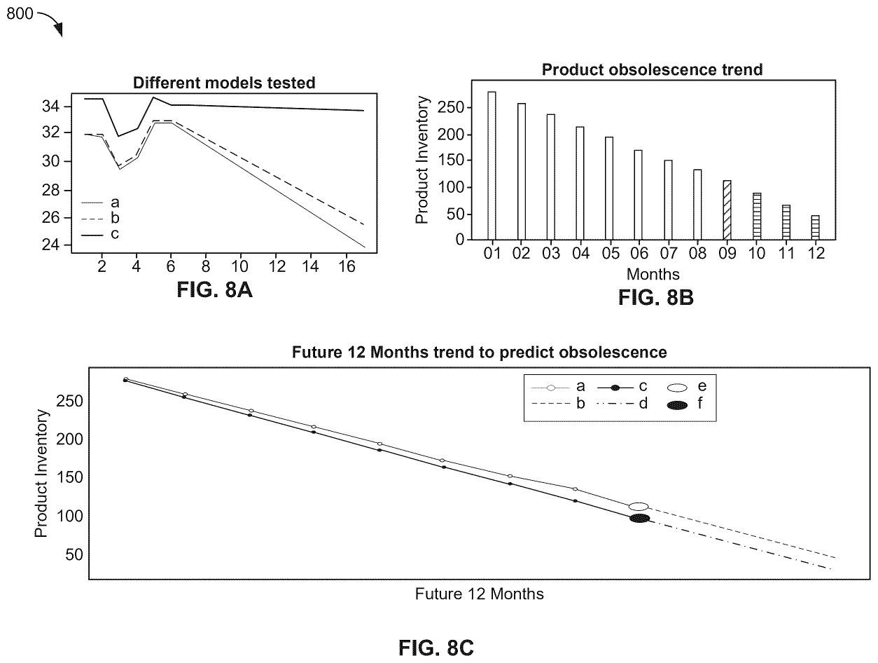

FIG. 8A-8C illustrates visual representation of user interface, in accordance with implementations of the present disclosure. The visual representations enhance user understanding, engagement, and decision-making by transforming complex and massive data into easily interpretable formats. As shown in FIG. 8A, the user interface may display the different models that were used to predict obsolescence. As shown in FIG. 8B, the user interface may display a graph for a particular model's prediction of obsolescence over the next 12 months. Furthermore, as shown in FIG. 8C, the user interface may display a graph of the actual product obsolescence trend over time. Specifically, visual representations enable users to identify the performance of different models, compare predicted and actual trends, and make informed decisions regarding product lifecycle management. In a nutshell, by displaying different models, predicted obsolescence trends, and actual product obsolescence trends in a graphical format, the user interface enhances user comprehension and decision-making capabilities in predicting obsolescence.

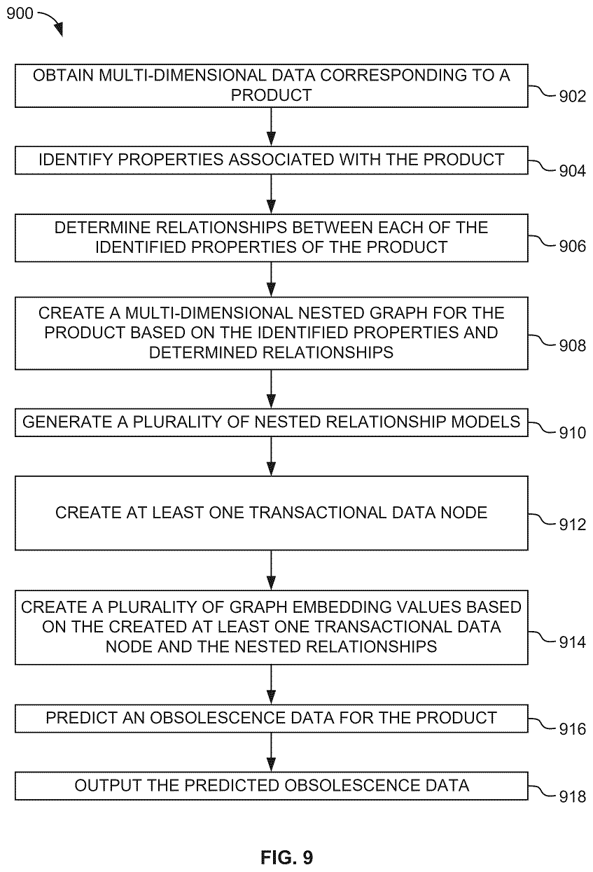

FIG. 9 illustrates the flow diagram of an example method 900 for obsolescence prediction, in accordance with implementations of the present disclosure. In some implementations, the method 900 may be executed within the system for obsolescence prediction as described in relation to FIG. 4.

At step 902, the method 900 includes obtaining multi-dimensional data corresponding to a product from a plurality of data sources 318. The multi-dimensional data may include, but not limited to, product size, product ingredients, a geographic location of the product, a customer lifestyle data, climate conditions, and a current sales data for the product. The multi-dimensional data is obtained by data ingestion system 304 for further processing and storage into database 316.

At step 904, the method 900 includes identifying properties associated with the product based on the obtained multi-dimensional data. Specifically, the data cluster module 336 extracts the product data and cluster/group the products based on type, nature, quantity, brand etc.

At step 906, the method 900 includes determining relationships between each of the identified properties of the product based on type of the properties and type of the product. Specifically, the properties and relationships determination module 338 determine the relationship between the customer & against the products purchased from each of the product clusters.

At step 908, the method 900 includes creating a multi-dimensional nested graph 412 for the product based on the identified properties and the determined relationships using a nested graph technique. The multi-dimensional nested graph 412 represents relationship of the determined properties with market demands of the product.

At step 910, the method 900 includes generating a plurality of nested relationship models 416 from the created multi-dimensional nested graph 412. Specifically, the relationship representation module 340 generates the plurality of nested relationship model 416 which represents the identified properties and the determined relationships for each product cluster. Further, the nested relationship model 416 are generated based on nested relationships common to specific group of products.

Additionally, the relationship representation module 340 further at step 912, in method 900, creates create at least one transactional data node indicating a relationship between the product and the current sales data based on the generated plurality of nested relationship model 416.

At step 914, the method 900 includes, creating a plurality of graph embedding values, by the node embedding module 342. Specifically, the node embedding module 342 creates the graph embedding values, based on the created at least one transactional data node and the nested relationships. The plurality of graph embedding values capture at least one of customer purchase patterns, a product trending history, product information, customer information, and demographics data.

At step 916, the method 900 includes, predict an obsolescence data for the product by the obsolescence predictor 350. The obsolescence predictor 350 predicts obsolescence based on the created plurality of graph embedding values, the customer purchase patterns, a product inventory forecast data and a sales data.

The obsolescence predictor 350, at step in method 900, outputs the predicted obsolescence data for the product on a user interface 354 of a user device.

In an example, in a grocery industry, multi-dimensional data corresponding to a grocery item is obtained like product data (for example SKU, category, brand, price, packaging, nutritional information and allergens), customer data (for example demographics, purchase history, loyalty program data and shopping cart analysis), market data (for example seasonality, weather patterns, economic indicators, competitor activity and promotional data) and store data (for example Inventory levels, sales data, store location, competition in the area).

Further, similar grocery items are clustered/grouped based on multi-dimensional data like category, brand, price, and target customer segment. Thereafter, relationships are identified between product attributes, customer purchasing behavior, and sales performance. For instance, impact of sales on promotions is identified, impact of weather on demand for certain products is identifies, or impact of new product introductions influencing the sales of existing items is identified. Further, the nested graph is generated which may include data of products, customers, stores, and external factors as nodes and relationships between these entities as edges. Moreover, the graph embedding values are created which may include numerical representations of the nested graph. Consequently, based on graph embedding values, sales data, inventory levels, and expiration dates, product obsolescence is predicted.

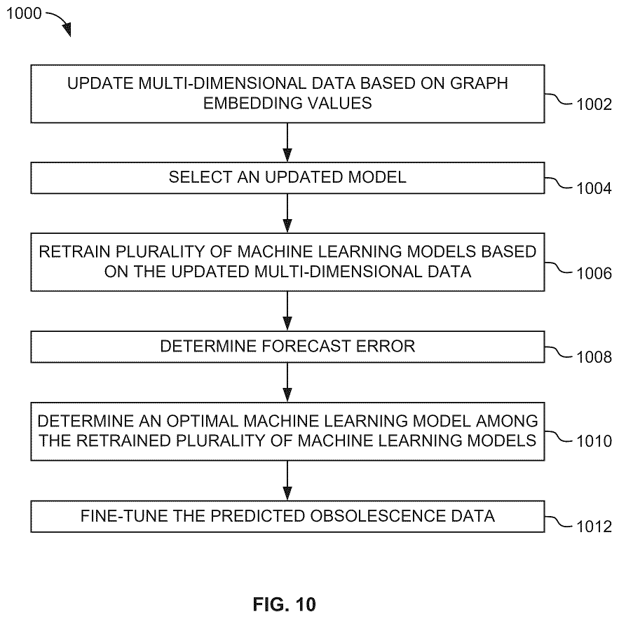

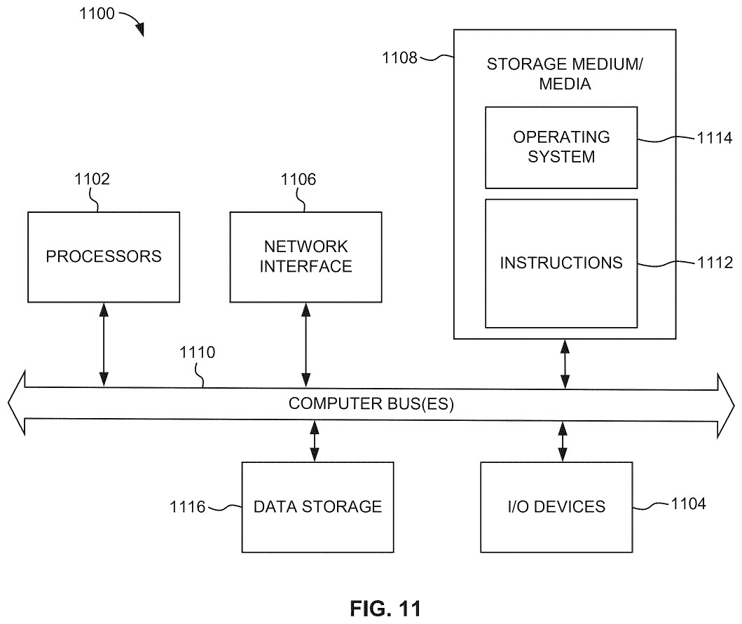

FIG. 10 illustrates the flow diagram of an example method 1000 for custom model training by obsolescence optimizer 344, in accordance with implementations of the present disclosure. In some implementations, the method 1000 may be executed within the system for obsolescence prediction as described in relation to FIG. 4.

At step 1002, the method 1000 includes, generating an updated multi-dimensional data based on the created plurality of graph embedding values by the node embedding module 342. Specifically, the model training module 346 generates the updated multi-dimensional data.

At step 1004, the method 1000 includes, selecting an updated model architecture for the updated multi-dimensional data based on a model capacity, by the model training module 346.

The model training module 346, at step 1006, in the method 1000, retrain a plurality of machine learning models based on the updated multi-dimensional data and the selected model architecture using a plurality of hyperparameters.

At step 1008, the method 1000 includes determining a forecast error for the predicted obsolescence data by validating performance of the retrained plurality of machine learning models based on weights assigned to each of the retrained plurality of machine learning models.

At step 1010, the method 1000 includes, determining an optimal machine learning model among the retrained plurality of machine learning models based on results of validation and the determined forecast error.

At step 1012, the method 1000 includes, fine-tune the predicted obsolescence data for the product based on the determined optimal machine learning model. Specifically, the predicted obsolescence data is fine-tuned by the model evaluation module 348.

Implementations of the present disclosure provides technical solutions to multiple technical problems that arise in the context of obsolescence prediction. For example, implementations of the present disclosure enable the system, by generating nested graph 412, to capture multi-dimensional features of the product like customer profile, location profile, customer purchase profile along with historic sales data to predict the obsolescence. By using nested graph 412, relationship between product properties and market demands can be determined. Furthermore, the nested graph 412 along with the graph embedding values represent the product's constituent properties, attributes, and their interdependencies. This representation enables the system to discern underlying patterns and trends within the data, even in the absence of extensive historical information, by leveraging existing relationships among entities. Thus, enabling the identification of trends, seasonality, and other recurring patterns as applicable within the underlying data structure.

FIG. 1100 illustrates a computer system 1100 that may be used to implement the system to predict obsolescence. More particularly, computing machines such as desktops, laptops, smartphones, tablets, and wearables which may be used to implement the tasks that may have the structure of the computer system 1100. The computer system 1100 may include additional components not shown and that some of the process components described may be removed and/or modified. In another example, a computer system 1100 may be deployed on external-cloud platforms such as cloud, internal corporate cloud computing clusters, organizational computing resources, and/or the like.

The computer system 1100 includes processor(s) 1102, such as a central processing unit, ASIC or another type of processing circuit, input/output devices 1104, such as a display, mouse keyboard, etc., a network interface 1106, such as a Local Area Network (LAN), a wireless 802.11x LAN, a 3G or 4G mobile WAN or a WiMax WAN, and a computer-readable medium 1108. Each of these components may be operatively coupled to a bus 1110. The computer-readable medium 1108 may be any suitable medium that participates in providing instructions to the processor(s) 1102 for execution. For example, the computer-readable medium 1108 may be non-transitory or non-volatile medium, such as a magnetic disk or solid-state non-volatile memory or volatile medium such as RAM. The instructions or modules stored on the computer-readable medium 1108 may include machine-readable instructions 1112 executed by the processor(s) 1102 that cause the processor(s) 1102 to perform the methods and functions of the system to predict obsolescence.

The system may be implemented as software stored on a non-transitory processor-readable medium and executed by the processors 1102. For example, the computer-readable medium 1108 may store an operating system 1114, such as MAC OS, MS WINDOWS, UNIX, or LINUX, and code for the system. The operating system 1114 may be multi-user, multiprocessing, multitasking, multithreading, real-time, and the like. For example, during runtime, the operating system 1114 is running and the code for the system is executed by the processor(s) 1102.

The computer system 1100 may include a data storage 1116, which may include non-volatile data storage. The data storage 1116 stores any data used or generated by the system.

The network interface 1106 connects the computer system 1100 to internal systems for example, via a LAN. Also, the network interface 1106 may connect the computer system 1100 to the Internet. For example, the computer system 1100 may connect to web browsers and other external applications and systems via the network interface 1106.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term computing system encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touchpad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (LAN) and a wide area network (WAN), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A system, comprising:
one or more processor; and
one or more memory communicably coupled to the one or more processor, wherein the memory comprises processor-executable instructions which, when executed by the processor, cause the processor to:
obtain multi-dimensional data corresponding to a product from a plurality of data sources, wherein the multi-dimensional data comprises at least one of a product size, product ingredients, a geographic location of the product, a customer lifestyle data, climate conditions, and a current sales data for the product;
identify properties associated with the product based on the obtained multi-dimensional data;
determine relationships between each of the identified properties of the product based on type of the properties and type of the product;
create a multi-dimensional nested graph for the product based on the identified properties and the determined relationships using a nested graph technique, wherein the multi-dimensional nested graph represents relationship of the determined properties with market demands of the product;
generate a plurality of nested relationship models from the created multi-dimensional nested graph, wherein the plurality of nested relationship models represent the identified properties and the determined relationships for a group of products, and wherein the plurality of nested relationship models are generated based on nested relationships common to specific group of products;
create at least one transactional data node indicating a relationship between the product and the current sales data based on the generated plurality of nested relationship models;
create a plurality of graph embedding values based on the created at least one transactional data node and the nested relationships, wherein the plurality of graph embedding values capture at least one of customer purchase patterns, a product trending history, product information, customer information, and demographics data;
predict an obsolescence data for the product based on the created plurality of graph embedding values, the customer purchase patterns, a product inventory forecast data and a sales data; and
output the predicted obsolescence data for the product on a user interface of a user device.

2. The system of claim 1, wherein the processor is configured to:
generate an updated multi-dimensional data based on the created plurality of graph embedding values;
select an updated model architecture for the updated multi-dimensional data based on a model capacity;
retrain a plurality of machine learning models based on the updated multi-dimensional data and the selected model architecture using a plurality of hyperparameters;
determine a forecast error for the predicted obsolescence data by validating performance of the retrained plurality of machine learning models based on weights assigned to each of the retrained plurality of machine learning models;
determine an optimal machine learning model among the retrained plurality of machine learning models based on results of validation and the determined forecast error; and
fine-tune the predicted obsolescence data for the product based on the determined optimal machine learning model.

3. The system of claim 1, wherein the processor is to:
simulate performance of the product in a virtual environment based on the predicted obsolescence data for the product;
define at least one action to be performed on the product based on results of simulation, wherein the at least one action comprises modifying product maintenance cycle, a product production cycle, and inventory numbers; and
remotely execute, in real-time, the defined at least one action at an industrial plant of the product by communicating the at least one action as a control signal to at least one of a control station and a control device deployed within the industrial plant.

4. The system of claim 1, wherein to create the at least one transactional data node indicating the relationship between the product and the current sales data based on the generated plurality of nested relationship models, the processor is to:
identify a customer behavior on purchase patterns by applying user specific data into a trained machine-learning model;
obtain inventory levels, seasonal sales data, and trending products data related to the product from a plurality of external data sources;
determine the relationship between the product and the current sales data based on the identified customer behavior on purchase patterns, the obtained inventory levels, the seasonal sales data, and the trending products data; and
create at least one transactional data node indicating the relationship between the product and the current sales data.

5. The system of claim 1, wherein the processor is to:
cluster a plurality of products into a plurality of product categories based on a type, a nature, a quantity, and a brand using a data clustering model; and
cluster the customer information associated with the plurality of products based on products purchased together at the same time using a generative artificial intelligence (AI) model.

6. The system of claim 1, wherein to create the multi-dimensional nested graph based on the identified properties and the determined relationships using the nested graph technique, the processor is to:
extract relationships between a customer and a plurality of products purchased by the customer from each of the plurality of product categories;
extract inventory information of the plurality of products purchased by the customer from each of the plurality of product categories;
assign a plurality of nodes of a connected graph with the product information based on the extracted inventory information and assign a plurality of edges of the connected graph with extracted relationships between the customer and the plurality of products purchased, and the determined relationships between each of the identified properties of the product; and
create a multi-dimensional nested graph based on the assigned nodes, and the assigned edges.

7. The system of claim 1, wherein to create the plurality of graph embedding values based on the created at least one transactional data node and the nested relationships, the processor is to:
create a sample data comprising information associated with each of nested nodes and corresponding properties of a product;
generate a synthetic nested node data for the created sample data using a large language model;
generate a hypothetical nested node graph for the product based on the generated synthetic nested node data;
create the plurality of graph embedding values for the generated hypothetical nested node graph using a trained graph network model; and
replicate the created plurality of graph embedding values for original enterprise nested nodes.

8. The system of claim 7, wherein to create the plurality of graph embedding values for the generated hypothetical nested node graph using the trained graph network model, the processor is to:
compute a nested metric proportionate value for product clusters related to the multidimensional data, wherein the multidimensional data comprises nested set of relationships along with connected graphs and edges; and
create the plurality of graph embedding values for the generated hypothetical nested node graph based on the computed nested metric proportionate value.

9. The system of claim 1, wherein to generate the plurality of nested relationship models from the created multi-dimensional nested graph, the processor is to:
generate a node level relationship node across product clusters, a cluster level relationship node and a nested weight relationship node for the created multi-dimensional nested graph;
determine a nested metric value for identifying close network nodes between each of the generated node level relationship node across the product clusters, the cluster level relationship node and the nested weight relationship node; and
generate the plurality of nested relationship models based on the determined nested metric value.

10. The system of claim 1, wherein to predict the obsolescence data for the product based on the created plurality of graph embedding values, the customer purchase patterns, the forecast data and the sales data; the processor is to:
identify the customer purchase patterns for the product comprising high confidence score by applying the created plurality of graph embedding values onto a trained forecast machine learning (ML) model;
predict relationships across the product, the current sales data, a product purchase history with the identified customer purchase patterns using the trained forecast machine learning (ML) model;
determine a product forecast data based on the predicted relationships across the product, the current sales data, and the product purchase history with the identified customer purchase patterns; and
predict the obsolescence data for the product for a defined period of time based on the determined product forecast data and the predicted relationships across the product, the current sales data, and the product purchase history with the identified customer purchase patterns, wherein the obsolescence data comprises at least one of the market demand data, the customer demand data customer forecast data, future sales insight, purchasing trends, recommendations on product inventory allocations, route schedules, and transportation cost.

11. A method comprising:
obtaining, by a processor, a multi-dimensional data corresponding to a product from a plurality of data sources, wherein the multi-dimensional data comprises at least one of a product size, product ingredients, a geographic location of the product, a customer lifestyle data, climate conditions, and a current sales data for the product;
identifying, by the processor, properties associated with the product based on the obtained multi-dimensional data;
determining, by the processor, relationships between each of the identified properties of the product based on type of the properties and type of the product;
creating, by the processor, a multi-dimensional nested graph for the product based on the identified properties and the determined relationships using a nested graph technique, wherein the multi-dimensional nested graph represents relationship of the determined properties with market demands of the product;
generating, by the processor, a plurality of nested relationship models from the created multi-dimensional nested graph, wherein the plurality of nested relationship models represent the identified properties and the determined relationships for a group of products, and wherein the plurality of nested relationship models are generated based on nested relationships common to specific group of products;
creating, by the processor, at least one transactional data node indicating a relationship between the product and the current sales data based on the generated plurality of nested relationship models;
creating, by the processor, a plurality of graph embedding values based on the created at least one transactional data node and the nested relationships, wherein the plurality of graph embedding values capture at least one of customer purchase patterns, a product trending history, product information, customer information, and demographics data;
predicting, by the processor, an obsolescence data for the product based on the created plurality of graph embedding values, the customer purchase patterns, a product inventory forecast data and a sales data; and
outputting, by the processor, the predicted obsolescence data for the product on a user interface of a user device.

12. The method of claim 11, further comprising:
generating, by the processor, an updated multi-dimensional data based on the created plurality of graph embedding values;
selecting, by the processor, an updated model architecture for the updated multi-dimensional data based on a model capacity;
retraining, by the processor, a plurality of machine learning models based on the updated multi-dimensional data and the selected model architecture using a plurality of hyperparameters;
determining, by the processor, a forecast error for the predicted obsolescence data by validating performance of the retrained plurality of machine learning models based on weights assigned to each of the retrained plurality of machine learning models;
determining, by the processor, an optimal machine learning model among the retrained plurality of machine learning models based on results of validation and the determined forecast error; and
fine-tuning, by the processor, the predicted obsolescence data for the product based on the determined optimal machine learning model.

13. The method of claim 11, further comprising:
simulating, by the processor, performance of the product in a virtual environment based on the predicted obsolescence data for the product;
defining, by the processor, at least one action to be performed on the product based on results of simulation, wherein the at least one action comprises modifying product maintenance cycle, a product production cycle, and inventory numbers; and
remotely executing, by the processor, in real-time, the defined at least one action at an industrial plant of the product by communicating the at least one action as a control signal to at least one of a control station and a control device deployed within the industrial plant.

14. The method of claim 11, wherein creating the at least one transactional data node indicating the relationship between the product and the current sales data based on the generated plurality of nested relationship models comprises:
identifying, by the processor, a customer behavior on purchase patterns by applying user specific data into a trained machine-learning model;
obtaining, by the processor, inventory levels, seasonal sales data, and trending products data related to the product from a plurality of external data sources;
determining, by the processor, the relationship between the product and the current sales data based on the identified customer behavior on purchase patterns, the obtained inventory levels, the seasonal sales data, and the trending products data; and
creating, by the processor, at least one transactional data node indicating the relationship between the product and the current sales data.

15. The method of claim 11, wherein creating the multi-dimensional nested graph based on the identified properties and the determined relationships using the nested graph technique comprises:
extracting, by the processor, relationships between a customer and a plurality of products purchased by the customer from each of the plurality of product categories;
extracting, by the processor, inventory information of the plurality of products purchased by the customer from each of the plurality of product categories;
assigning, by the processor, a plurality of nodes of a connected graph with the product information based on the extracted inventory information and assigning, by the processor, a plurality of edges of the connected graph with extracted relationships between the customer and the plurality of products purchased, and the determined relationships between each of the identified properties of the product; and
creating, by the processor, a multi-dimensional nested graph based on the assigned nodes, and the assigned edges.

16. The method of claim 11, wherein creating the plurality of graph embedding values based on the created at least one transactional data node and the nested relationships comprise:
creating, by the processor, a sample data comprising information associated with each of nested nodes and corresponding properties of a product;
generating, by the processor, a synthetic nested node data for the created sample data using a large language model;
generating, by the processor, a hypothetical nested node graph for the product based on the generated synthetic nested node data;
creating, by the processor, the plurality of graph embedding values for the generated hypothetical nested node graph using a trained graph network model; and
replicating, by the processor, the created plurality of graph embedding values for original enterprise nested nodes.

17. The method of claim 16, wherein creating the plurality of graph embedding values for the generated hypothetical nested node graph using the trained graph network model comprises:
computing, by the processor, a nested metric proportionate value for product clusters related to the multidimensional data, wherein the multidimensional data comprises nested set of relationships along with connected graphs and edges; and
creating, by the processor, the plurality of graph embedding values for the generated hypothetical nested node graph based on the computed nested metric proportionate value.

18. The method of claim 11, wherein generating the plurality of nested relationship models from the created multi-dimensional nested graph comprises:
generating, by the processor, a node level relationship node across product clusters, a cluster level relationship node and a nested weight relationship node for the created multi-dimensional nested graph;
determining, by the processor, a nested metric value for identifying close network nodes between each of the generated node level relationship node across the product clusters, the cluster level relationship node and the nested weight relationship node; and
generating, by the processor, the plurality of nested relationship models based on the determined nested metric value.

19. The method of claim 11, wherein predicting the obsolescence data for the product based on the created plurality of graph embedding values, the customer purchase patterns, the forecast data and the sales data comprises:
identifying, by the processor, the customer purchase patterns for the product comprising high confidence score by applying the created plurality of graph embedding values onto a trained forecast machine learning (ML) model;
predicting, by the processor, relationships across the product, the current sales data, a product purchase history with the identified customer purchase patterns using the trained forecast machine learning (ML) model;
determining, by the processor, a product forecast data based on the predicted relationships across the product, the current sales data, and the product purchase history with the identified customer purchase patterns; and
predicting, by the processor, the obsolescence data for the product for a defined period of time based on the determined product forecast data and the predicted relationships across the product, the current sales data, and the product purchase history with the identified customer purchase patterns, wherein the obsolescence data comprises at least one of the market demand data, the customer demand data customer forecast data, future sales insight, purchasing trends, recommendations on product inventory allocations, route schedules, and transportation cost.

20. A non-transitory computer readable medium comprising a processor-executable instructions that cause a processor to:
obtain a multi-dimensional data corresponding to a product from a plurality of data sources, wherein the multi-dimensional data comprises at least one of a product size, product ingredients, a geographic location of the product, a customer lifestyle data, climate conditions, and a current sales data for the product;
identify properties associated with the product based on the obtained multi-dimensional data;
determine relationships between each of the identified properties of the product based on type of the properties and type of the product;
create a multi-dimensional nested graph for the product based on the identified properties and the determined relationships using a nested graph technique, wherein the multi-dimensional nested graph represents relationship of the determined properties with market demands of the product;
generate a plurality of nested relationship models from the created multi-dimensional nested graph, wherein the plurality of nested relationship models represent the identified properties and the determined relationships for a group of products, and wherein the plurality of nested relationship models are generated based on nested relationships common to specific group of products;
create at least one transactional data node indicating a relationship between the product and the current sales data based on the generated plurality of nested relationship models;
create a plurality of graph embedding values based on the created at least one transactional data node and the nested relationships, wherein the plurality of graph embedding values capture at least one of customer purchase patterns, a product trending history, product information, customer information, and demographics data;
predict an obsolescence data for the product based on the created plurality of graph embedding values, the customer purchase patterns, a product inventory forecast data and a sales data; and
output the predicted obsolescence data for the product on a user interface of a user device.
